(19) United States
(12) Patent Application Publication
(10) Pub. No.: US 2013/0024306 A1
(43) Pub. Date: Jan. 24, 2013

(54) SYSTEMS AND METHODS FOR CHARGING ELECTRIC VEHICLES

(71) Applicants: Kunal Pankaj Shah, Redwood City, CA (US); Jay Ramasastry, Reno, NV (US)

(72) Inventors: Kunal Pankaj Shah, Redwood City, CA (US); Jay Ramasastry, Reno, NV (US)

(73) Assignee: SILVER SPRING NETWORKS, INC., Redwood City, CA (US)

(21) Appl. No.: 13/639,525

(22) PCT Filed: Feb. 4, 2011
(86) PCT No.: PCT/US2011/023734

§ 371 Date: Oct. 5, 2012

Related U.S. Application Data
(60) Provisional application No. 61/321,585, filed on Apr. 7, 2010.
(60) Provisional application No. 61/367,204, filed on Jul. 23, 2010.

(51) Int. Cl. G06Q 20/40; G06Q 20/20; G06Q 20/34

(52) U.S. Cl. 705/17

(57) ABSTRACT

Systems and methods for controlling for distributing power to electric vehicles. The system includes a vehicle charging key (“VCK”) that is operable to communicate with both a vehicle and a utility communications network. The VCK includes a processor, a memory, and one or more radios for communicating with the vehicle and the utility communications network. The VCK receives information from the vehicle, such as location information and vehicle battery state-of-charge (“SOC”) information, and transmits the information to a back office system (“BOS”), such as a utility provider or a credit card company. The BOS generates utility pricing or charging information based on, for example, time of day, and transmits the utility pricing information back to the VCK. A transaction module of the VCK receives payment information from a user that includes a payment selection. The payment selection includes a payment type (e.g., credit card, prepaid account, utility account, etc.). The VCK transmits the payment information to the BOS, and the BOS responds with a charge authorization signal.

### RELATED APPLICATIONS

This application claims the benefit of previously-filed, co-pending U.S. Provisional Patent Application No. 61/321,585, filed Apr. 7, 2010, and previously-filed, co-pending U.S. Provisional Patent Application No. 61/367,204, filed Jul. 23, 2010, the entire contents of both of which are hereby incorporated by reference.

### BACKGROUND

The present invention relates to the charging of electric vehicles.

Electric vehicles or gas-electric plug-in-hybrid vehicles include motors that are powered by electrical current from a rechargeable battery within the vehicle. In addition to being charged using techniques such as regenerative braking, many of these vehicles are also able to be charged from mains electricity.

### SUMMARY

Charging a vehicle battery from mains power increases the range that the vehicle is able to travel. However, unlike gasoline which can be purchased at any one of thousands of filling stations, electricity is distributed over large distances to individual utility customers, and is paid for through utility bills associated with the customer's utility account. Such a power distribution and payment method imposes a variety of limitations on a user's ability to charge an electric vehicle. For example, when charging the electric vehicle at the user's residence, the corresponding cost to charge the vehicle is represented by an increase in monthly kilowatt hours of usage and is applied to the utility account. However, when charging the vehicle at a workplace, a friend's house, or in a different utility territory (e.g., a different state), the cost to charge the vehicle is applied to the utility account associated with the workplace, the friend's house, or other location where the vehicle is being charged.

The invention provides a payment system which enables the user to apply the cost to charge the vehicle to, for example, the user's personal utility account, a credit card, or another alternative payment type (e.g., a prepaid credit card, a prepaid debit card, online payment service, etc.). To achieve such a payment system, a vehicle charging key (“VCK”) that is configured to communicate with both the vehicle and a utility communications network is used as an interface or gateway between the utility communications network and the vehicle. The VCK includes, for example, a processor, a memory, and one or more radios for communicating with the vehicle and the utility communications network. The VCK also includes a network interface controller (“NIC”) and a transaction module. In some embodiments, the VCK includes a transaction module, a NIC, and a charging unit interface. The NIC establishes communication with, transmits information to, and receives information from both the utility communications network and the vehicle. The NIC transmits information to a back office system (“BOS”), such as a utility provider, a credit card company, or another financial institution. The information includes, among other things, payment information, location information, etc. The BOS transmits information to the NIC, such as pricing information for one or more charging locations near the vehicle or along the route to the vehicle's destination. The transaction module of the VCK receives information from the user including a payment selection. The payment selection includes, among other things, a payment type. The NIC transmits the information through the utility communications network to the BOS. The BOS responds to the information with a charge authorization signal. The VCK receives the charge authorization signal, and generates a corresponding charge enable or charge prohibition signal based on the charge authorization signal. The charge enable signal and the charge prohibition signal selectively enable or prohibit the vehicle battery from being charged.

In one embodiment, the invention provides a vehicle charging device that is configured to communicate with a vehicle. The vehicle includes a rechargeable battery, and the vehicle charging device includes a transaction module, a network interface controller, and a charging unit interface. The transaction module is configured to moderate a vehicle battery charging payment transaction. The network interface controller is configured to communicate with a back office system and receive a charge authorization signal based on the vehicle battery charging payment transaction, and the charging unit interface is configured to generate a charge enable signal based on the charge authorization signal.

In another embodiment, the invention provides a vehicle charging device configured to communicate with a vehicle that includes a rechargeable battery. The vehicle charging device includes a transaction module configured to receive a charging preference and generate payment information including a payment selection. The vehicle charging device also includes a self-configuring network interface module configured to transmit a network registration signal to a communications network to register the vehicle charging device as a node within the communications network and transmit the payment information to a back office system.

In another embodiment, the invention provides a vehicle charging device configured to communicatively connect to a vehicle that includes a rechargeable battery. The vehicle charging device includes, among other things, a transaction module and a self-configuring network interface module. The transaction module is configured to receive a charging preference and generate payment information including a payment selection. The charging preference is received from a user or a memory within the vehicle charging device. The payment selection includes a payment type. The network interface module is configured to communicatively connect to an access point of a first network, transmit the payment information to a back office system, and receive a charging authorization signal based on the payment information.

In another embodiment, the invention provides a method of distributing power from a power grid to a vehicle and charging a battery within the vehicle. The power grid is associated with a utility communications network that includes a back office system, an access point, and a vehicle charging device. The method includes establishing communication with the vehicle charging device, receiving payment information from the vehicle charging device, the payment information including a payment selection, and transmitting a charging authorization signal that provides authorization to selectively control the charging of a vehicle battery.

In another embodiment, the invention provides a method of distributing power through a power distribution system. The power distribution system includes a back office system, an access point, and a vehicle charging device, and operates over one or more interconnected networks to charge a vehicle battery. The method includes establishing communication with the access point, receiving a vehicle battery state-of-charge, and receiving data from the back office system. The data received from the back office system includes utility pricing information. The method also includes transmitting payment information to the back office system, the payment information including a payment selection, and receiving a charging authorization signal from the back office system. The charging authorization signal is based at least in part on the payment selection, and the charging authorization signal provides authorization to selectively control the charging of the vehicle battery.

In another embodiment, the invention provides a power distribution system. The power distribution system includes a back office system, an access point, and a vehicle charging device. The back office system is configured to communicatively connect to a utility network or power distribution system, and the access point is configured to connect to the back office system through a communications network. The vehicle charging device includes a network interface module, configured to connect to the access point through a local area network, and moderate a vehicle battery charging payment transaction. The back office system is further configured to identify the vehicle charging device (e.g., using a network address or similar identifier), receive payment information from the vehicle charging device, and generate a charging authorization signal based on the payment information. The payment information includes, among other things, a payment selection which indicates a payment type.

Other aspects of the invention will become apparent by consideration of the detailed description and accompanying drawings.

### BRIEF DESCRIPTION OF THE DRAWINGS

FIG. 1 illustrates a system for charging a plurality of electric vehicles.

FIG. 2 illustrates a utility communications network according to an embodiment of the invention.

FIG. 3 illustrates a vehicle charging system according to an embodiment of the invention.

FIGS. 4-5 are a process for connecting a vehicle charging key (“VCK”) to a utility communications network.

FIG. 6 illustrates a VCK according to an embodiment of the invention.

FIG. 7 illustrates a VCK according to another embodiment of the invention.

FIG. 8 illustrates a utility node according to an embodiment of the invention.

FIG. 9 illustrates an access point according to an embodiment of the invention.

FIG. 10 illustrates a back office system according to an embodiment of the invention.

FIGS. 11-13 are a process for charging an electric vehicle.

FIG. 14 illustrates a vehicle charging system according to another embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Embodiments of the invention relate to systems, devices, and methods for controlling the charging of batteries using a power distribution system. The system includes one or more nodes configured to communicate with a back office system (“BOS”) via one or more networks. The nodes correspond to any of a variety of power distribution locations within the power distribution system. For example, the nodes correspond to residential or commercial utility modules or meters, or vehicle charging keys (“VCKs”). The VCKs may be configured to function as a gateway or interface to control the charging of one or more rechargeable devices. The rechargeable devices include, for example, electric vehicles or other devices which include rechargeable batteries. The electric vehicles themselves may not be configured to communicate with the BOS. Rather, the electric vehicles can be configured to communicate with a VCK via a wired or wireless communications network. For example, the VCK and the vehicle communicate over a short-range wireless communication network such as a wireless personal area network (“WPAN”) (e.g., Bluetooth, ZigBee), Wi-Fi, or a network using another protocol. The VCK receives information from the vehicle related to, among other things, vehicle battery state-of-charge (“SOC”) information, location information, and the like. The VCK is configured to communicate with the BOS (e.g., a utility provider) through a utility communications network. The utility communications network is, for example, a wide are network (“WAN”) (e.g., the Internet, a cellular communications network, a satellite communications network, or the like). The VCK provides information through the WAN to the BOS related to, among other things, the vehicle battery state-of-charge (“SOC”), the location of the vehicle, and a payment selection. The BOS responds to the information with a charge authorization signal. The VCK receives and processes the charge authorization signal, and generates a corresponding charge enable, charge prohibition, or charge quantity signal based on the charge authorization signal. The VCK transmits at least one of the charge enable signal and the charge prohibition signal to the vehicle to selectively enable or prohibit the vehicle battery from being charged.

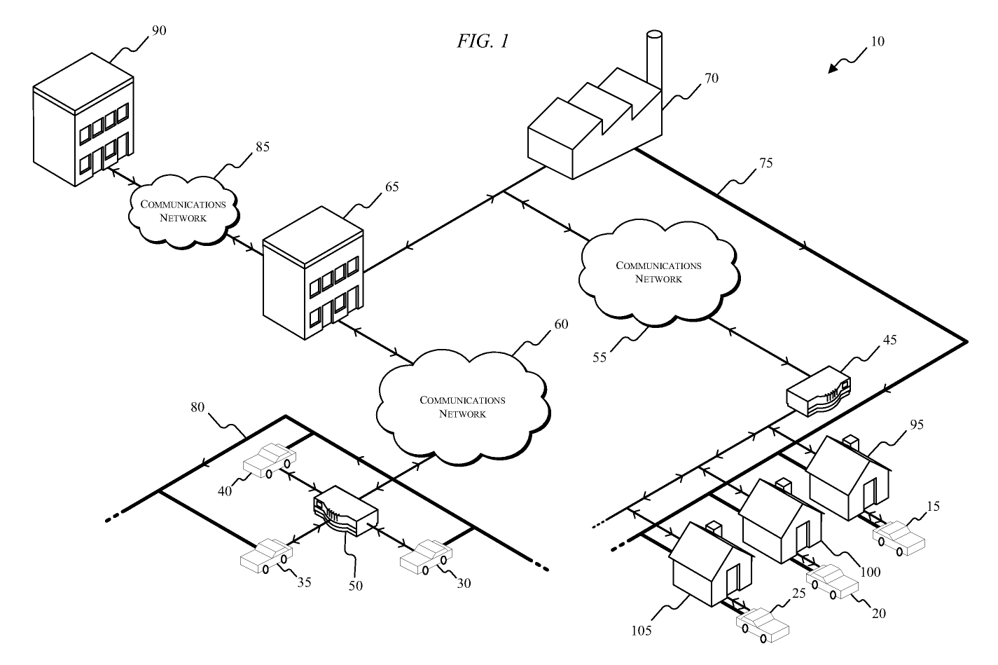

FIG. 1 illustrates a system 10 for charging a plurality of vehicles using electricity provided through a power distribution system including a utility communications network and a power grid network. The system 10 includes a plurality of vehicles 15-40, a first access point 45, a second access point 50, a first communications network 55, a second communications network 60, a first BOS 65, a power generation facility 70, power distribution lines 75 and 80, a third communications network 85, and a second BOS 90. The utility communications network includes the first access point 45, the second access point 50, the first communications network 55, the second communications network 60, the third communications network 85, the first BOS 65, and the second BOS 90. The utility communications network also includes a plurality of VCKs, as described below. The power grid network includes the power generation facility 70, and the power distribution lines 75 and 80.

The vehicles 15-40 are configured to electrically couple or connect the power grid network via a power cable or cord that provides mains electricity to the vehicle. Each of the vehicles 15-40 includes or is associated with a VCK or vehicle charging device (“VCD”) for controlling or moderating the charging of the vehicles 15-40. The VCK functions as a controller, a mediator, a gateway, and/or an interface between the vehicles 15-40 and the utility communications network. In the illustrated system, the vehicles 15, 20, and 25 are connected to residential or commercial properties 95, 100, and 105, respectively, for charging. The VCKs associated with the vehicles 15, 20, and 25 communicate with a network such as a local area network (“LAN”), a neighborhood area network (“NAN”), a home area network (“HAN”), or personal area network (“PAN”) using any of a variety of communications protocols, such as Wi-Fi, Bluetooth, ZigBee, or the like. This network is, in turn, configured to communicate with the first access point 45, which is associated with the first communications network 55. The first communications network 55 is, for example, wide area network (“WAN”) (e.g., a TCP/IP based network, Global System for Mobile Communications (“GSM”), General Packet Radio Service (“GPRS”), Code Division Multiple Access (“CDMA”), Evolution-Data Optimized (“EV-DO”), Enhanced Data Rates for GSM Evolution (“EDGE”), 3GSM, Digital Enhanced Cordless Telecommunications (“DECT”), Digital AMPS (“IS-136/TDMA”), or Integrated Digital Enhanced Network (“iDEN”), a Digital Advanced Mobile Phone System (“D-AMPS”), or the like. In other embodiments, the first communications network 55 is a second LAN, HAN, or PAN. The connections between the VCK and the LAN, and the connections between the LAN and the access point are, for example, wired connections, wireless connections, or a combination of wireless and wired connections. In some embodiments, the VCK communicates with the LAN using a wireless communications network, and the LAN communicates with the first access point 45 using a wired network connection.

The networks described above are, for example, self-configuring or mobile ad hoc networks (“MANETs”) which utilize a mesh network topology to provide redundancy to the utility communications network. In other embodiments, the networks have different network topologies, such as ring, star, line, tree, bus, or fully-connected network topologies. In the illustrated embodiment, the networks and the communication between the devices within the networks are protected using one or more encryption techniques, such as those techniques provided in the IEEE 802.1x standard for port-based network security, pre-shared key (“PSK”), Extensible Authentication Protocol (“EAP”), Wired Equivalency Privacy (“WEP”), Temporal Key Integrity Protocol (“TKIP”), Wi-Fi Protected Access (“WPA”), or the like.

The first access point 45 is located in a residential area and is communicatively coupled to, for example, one or more utility nodes or smart meters located in each of the residential properties 95, 100, and 105. The utility nodes located in each property communicatively connect to the VCK that is within or near each vehicle 15, 20, and 25. The first access point 45 connects each of the utility nodes and each of the VCKs to the first communications network 55. Each of the residential properties is also connected to the power distribution line 75 of the power grid network to receive electricity, and the vehicles 15, 20, and 25 are connected to (e.g., plugged in to) an outlet associated with the residential property to receive a vehicle battery charging current.

The second access point 50 is associated with a vehicle charging station, and is configured to communicate with a plurality of VCKs. The second access point 50 connects the VCKs for the vehicles 30, 35, and 40 to the second communications network 60. In some embodiments, the second communications network 60 is different than the first communications network 55. In other embodiments, the second communications network 60 is the same network or same type of network as the first communications network 55 (e.g., a TCP/IP based communications network). Although the vehicle charging station is illustrated as only including the second access point 50, in some embodiments of the invention, a vehicle charging station includes a plurality of nodes or utility nodes which individually communicate with the second communications network 60, or communicate with the second communications network 60 through one or more access points. The interactions between the VCKs, the vehicles 30, 35, and 40, the utility nodes, the first access point 45, the second access point 50, the first communications network 55, and the second communications network 60 are described in greater detail below.

The first communications network 55 and the second communications network 60 are communicatively connected to at least the first BOS 65 and the power generation facility 70. In some embodiments, the first BOS 65 is a utility provider and sets, among other things, electricity pricing rates (e.g., in kilowatt hours). The first BOS 65 communicates with the power generation facility 70 to determine the availability of electricity for the power grid network. The prices set by the first BOS 65 may vary based on the power generation facility 70's load demand, which varies continuously during a given day. The second BOS 90 is connected to the first BOS 65 through the third communications network 85, which is similar to the first and second networks 55 and 60 described above. The second BOS 90 is, for example, a credit card authority, financial institution, or the like. In some embodiments, the first BOS 65 and the second BOS 90 work in conjunction to generate a charge authorization signal which is sent through the utility communications network to a VCK.

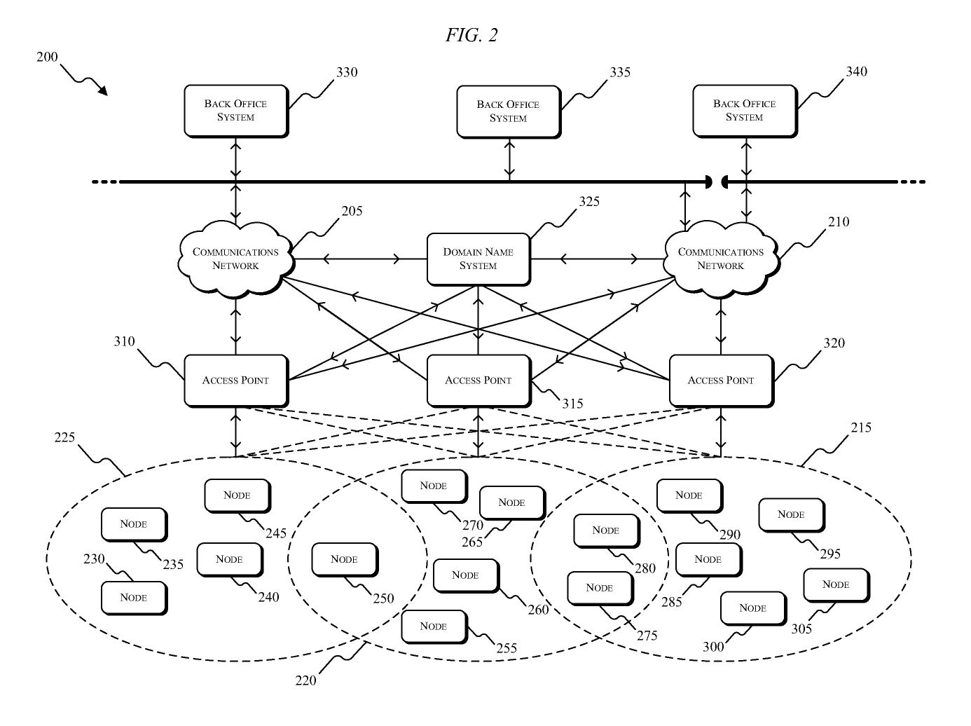

FIG. 2 is a block diagram of a utility communications network 200 for communicatively connecting one or more BOSs to one or more nodes. The utility communications network 200 includes a first communications network 205, a second communications network 210, a third communications network 215, a fourth communications network 220, and a fifth communications network 225. In some embodiments, the third, fourth, and fifth communications networks 215, 220, and 225 are LANs, NANs, HANs, or another similar short-range communications network. For descriptive purposes, the third, fourth, and fifth communications networks 215, 220, and 225 are described herein with respect to embodiments of the invention in which each of the third, fourth, and fifth communications networks 215, 220, and 225 are LANs.

The LANs 215, 220, and 225 are configured to connect nodes 230-305 and access points 310, 315, and 320. In the illustrated embodiments, each of LANs 215, 220, and 225 are configured to connect to each of the access points 310, 315, and 320. In other embodiments, one or more of the LANs 215, 220, and 225 are configured to connect to more or fewer access points. In some embodiments, the number of access points that each LAN is capable of connecting to is limited only by the number of access points within communications range of the LAN. For example, in highly populated urban or residential areas, each LAN is likely to be in communications range of a plurality of access points. In rural areas, however, each LAN is often only in communications range of a single access point.

The nodes are, for example, smart utility meters configured to measure a metered quantity (e.g., electricity, water, natural gas, etc.), a VCK, or an electric vehicle. The nodes include a network interface card (“NIC”) for communicating with the utility communications network 200, and include one or more radios (e.g., RF radios) or transceivers for communicating with the LANs 215, 220, and 225. The nodes 230-305 communicate directly with the access points 310, 315, and 320, or the nodes 230-305 communicated with the access points 310, 315, and 320 via other of the nodes 230-305. In other embodiments, additional devices, such as set top boxes (e.g., cable or satellite boxes), household appliances (e.g. refrigerators, heaters, lights, cooking appliances, etc.), computers or computing devices (e.g. game consoles, storage devices, PCs, laptops, servers, etc.), networking devices (e.g., relays, gateways, access points, routers, etc.), mobile phones, charge storage devices, entertainment devices (e.g. TVs, DVD players, gaming consoles, etc.), and other devices found in homes, businesses, roadways, parking lots, or other locations are nodes within the utility communications network 200.

A domain name system or server (“DNS”) 325 is connected to LANs 215, 220, and 225 through the access points 310, 315, and 320. In other embodiments, the DNS 325 is connected to the LANs 215, 220, and 225 through first and second communications networks 205 and 210 and then through the access points 310, 315, and 320. In some embodiments, the DNS 325 is capable of receiving and processing dynamic updates to provide a dynamic DNS (“DDNS”) service. The first and second communications networks 205 and 210 are similar to the communications networks 55 and 60 described above with respect to FIG. 1, and utilize any of a variety of communications protocols and topologies. In some embodiments, the communications networks 205 and 210 are WANs, and use one or more TCP/IP based communications protocols, such as IPv4, IPv6, or the like. In the illustrated embodiments, three BOSs 330, 335, and 340 are connected to the communications networks 205 and 210. Messages sent from the BOSs 330, 335, and 340 to one or more nodes within one or more of the LANs 215, 220, and 225 are sent by way of unique network addresses associated with the one or more nodes and registered with the DNS 325.

As described previously, the BOSs 330, 335, and 340 are, for example, a utility provider, a financial institution, or the like. The BOSs 330, 335, and 340 are implemented as a single device, a combination of devices, a network management system, a server, one or more computers, one or more network devices, one or more communications devices, one or more software applications, or a variety of components that is/are capable of communicating with one or more of the access points 310, 315, and 320 or nodes 230-305 via the first and second communication networks 205 and 210.

In some embodiments, the DNS 325 is dedicated to a single LAN, or is shared by a plurality of LANs. The DNS 325 maintains network addresses for the nodes 230-305 and their corresponding LANs 215, 220, and 225. In some embodiments, a node registered with more than one of the access points 310, 315, and 320 includes at least as many network addresses. The network addresses for the nodes 230-305 are stored or maintained in the DNS 325 or a node route registry. In some embodiments, the DNS 325 also maintains address allocation information, such as a node address allocation indicator or node preference indicator.

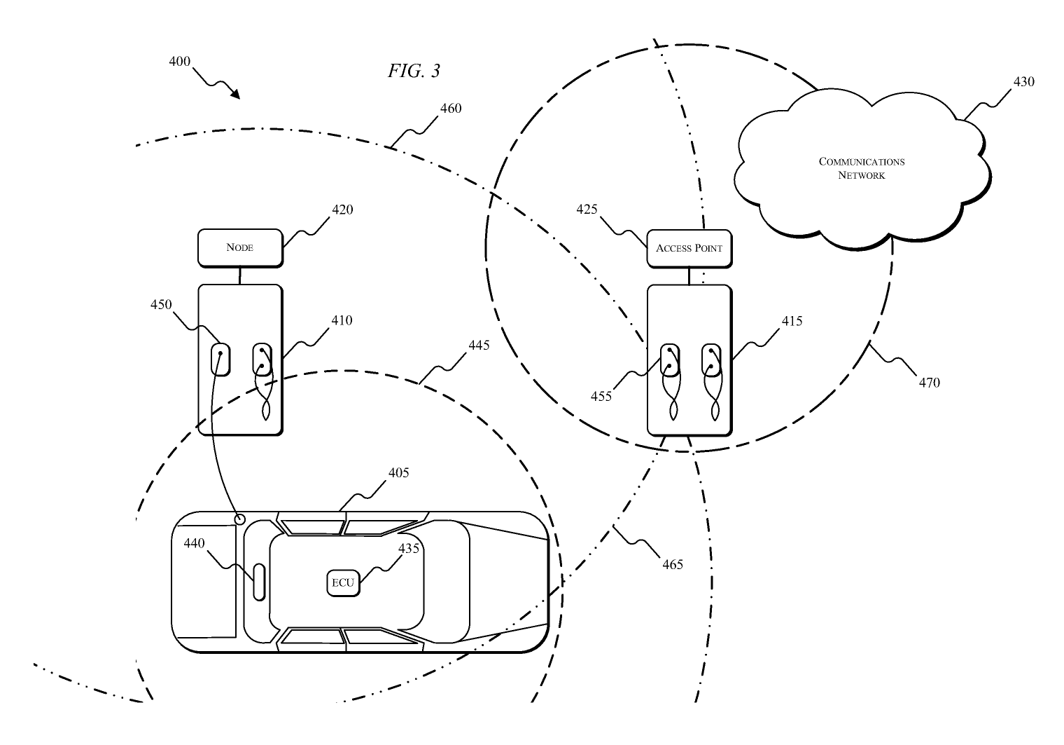

FIG. 3 illustrates a vehicle charging network 400 and the corresponding interactions between communications networks. The charging network 400 includes a vehicle 405, a first charging station 410, a second charging station 415, a network node 420, a network access point 425, and a communications network 430. The vehicle 405 includes an electronic control unit (“ECU”) 435, a VCK 440, and a rechargeable battery (not shown). Although the VCK 440 is illustrated as being within the vehicle 405 in the illustrated embodiment, the VCK 440 is non-integrally connected to the vehicle 405. For example, the VCK 440 is operably connected to the vehicle 405 via a wired or wireless connection to transmit and receive information from the vehicle 405 and/or receive power from the vehicle 405, but is removable from the vehicle 405. The node 420, the access point 425, and the communications network 430 are similar to the nodes, access points, and communications networks described above with respect to FIGS. 1 and 2. As such, the previously-described operation of these components can be applied to the embodiments of the invention described with respect to FIG. 3. The VCK 440 is also operably connected to the first charging station 410 or the second charging station 415 via a wired or wireless connection.

FIG. 3 is illustrative of an embodiment of the invention in which an electric vehicle 405 which is located at a filling station or electric vehicle charging station including at least a first charging terminal 450 and a second charging terminal 455, but the interactions between the vehicle 405, the VCK 440, the node 420, the access point 425, and the communications network 430 can be applied to embodiments of the invention in which the vehicle 405 is being charged at other locations (e.g., a residence). The vehicle 405 includes a first communications range 445. The first communications range 445 is, for example, the range of communication for a LAN using a short-range communications protocol such as Bluetooth, ZigBee, Wi-Fi, or the like, which is controlled by and provides information to and from the ECU 435. The ECU 435 includes, for example, one or more radios (not shown) for communicating with a variety of devices when those devices are within the first communications range 445. The ECU 435 is connected to the vehicle battery or a second ECU to control the operation, charging, and discharging of the vehicle battery. The ECU 435 is also configured to transmit information related to the current state of the vehicle battery to one or more devices within the first communications range 445. For example, the information includes vehicle battery SOC information, a location of the vehicle, historical charging or discharging information, destination information, auxiliary power requirements information, and the like.

The vehicle 405 is configured to communicate with the VCK 440 when the VCK is within the first communications range 445. The VCK 440 receives the information from the vehicle 405 related to, for example, the vehicle battery SOC information. The VCK 440 is configured to operate as a moderator, a controller, an interface, or a gateway between the vehicle 405 and a charging power source (e.g., the node 420 and the first charging terminal 450, or the access point 425 and the second charging terminal 455).

As described in greater detail below, the VCK 440 is a portable device which is capable of being used with any number of different vehicles, and is not a dedicated device solely for use with the vehicle 405. The VCK 440 includes one or more radios and at least a second communications range 460. In the illustrated embodiment, the second communications range 460 is illustrated as being in communications range of and communicating with both the vehicle 405 and the node 420. In other embodiments, the VCK 440 is configured to communicate with the vehicle 405 using a first network and first network protocol (e.g., Bluetooth, ZigBee, or the like), and is configured to communicate with the node 420 using a second network and a second network protocol (e.g., TCP/IP, or the like).

The first and second charging terminals 450 and 455 are connected to the power grid network and are operable to provide a charging current to the vehicle 405 to charge the vehicle battery. The first and second charging terminals 450 and 455 are connected to a node 420 and an access point 425, respectively. In some embodiments, the node 420 and the access point 425 are substantially similar devices, and the only distinction between the two is the relative proximity of each to the communications network 430. In such embodiments, the closest node to the communications network 430 is referred to as the access point. In other embodiments, the node 420 and the access point 425 are configured differently. For example, the access point 425 is configured to communicate over a greater distance than the node 420, or the access point 425 is configured as a hub to receive network communications from a plurality of neighboring nodes.

The node 420 and the access point 425 are configured to communicate with one another and the communications network 430 using a protocol such as TCP/IP. For example, in the illustrated embodiment, the node 420 is outside of communications range with the communications network 420. As such, the node 420 communicatively connects to the access point 425 which is within a third communications range associated with the node 420. The access point 425 then communicates with the communications network 430. As described above, the communications network 430 is connected to, among other things, a DNS and at least one BOS, such as a utility provider, a credit card company, a financial institution, or the like.

In some embodiments, the charging stations 410 and 415 are included in parking meters. In such embodiments, a user is able to pay for both parking and the electricity to charge the vehicle 405 at the same time. The parking meter includes one or more radios, a USB port, or another suitable interface for connecting to and communicating with the VCK 440. The user is then able to pay a parking fee by, for example, connecting the VCK 440 to the parking meter via the USB port. Additionally or alternatively, the VCK 440 is configured to wirelessly connect to the parking meter using any of the communications protocols described above.

In some embodiments, each parking meter includes an ID that is used to communicate with a master parking meter. The master parking meter includes, for example, a network interface controller (“NIC”) and a radio (e.g., a GPRS radio). The master parking meter is configured as a node within the utility communications network and communicates through the utility communications network as described herein. The parking meters not configured as nodes within the utility communications network (i.e., the non-master parking meters) are configured to communicate with the master parking meter through either a wired or a wireless connection. When a parking meter recognizes the VCK 440, the parking meter sends a message to the master parking meter (e.g., unless the VCK 440 communicates directly with the master parking meter) to establish a connection with the VCK 440. The master parking meter also receives additional information related to, for example, a period of time for which the user wants to park the vehicle. Once the master parking meter establishes communication with the VCK 440, the user is able to pay for parking, electricity for charging, or both using a credit card, prepaid account, a web-based service, or a utility account as described herein. As an illustrative example, the VCK 440 functions as a credit card to pay a parking fee and for charging the vehicle.

In another embodiment, the VCK 440 communicates with and transmits parking payment information to the BOS in a manner similar to that described above with respect to charging the vehicle. The parking payment information includes, for example, a parking selection (e.g., the amount of time the vehicle will be parked at the meter, stall number, etc.). The BOS authenticates and confirms the payment information and provides an acknowledgement or authorization signal to the VCK 440 and/or the parking meter to indicate that the parking payment transaction was completed. If the transaction failed, the user is prompted by the VCK 440, the parking meter, or both to select an alternative payment method. In some embodiments, the VCK 440 is also used to remotely add time to a parking meter or initiate additional charging. For example, to prevent having to walk back to the vehicle, the user is able to use the VCK 440 from another location away from the parking meter and add time to the meter, initiate/continue charging, or the like. The VCK 440, the BOS, or the parking meter can also provide the user with alerts or reminders (e.g., SMS, email, auditory, visual, tactile, etc.) associated with the amount of time remaining on the meter.

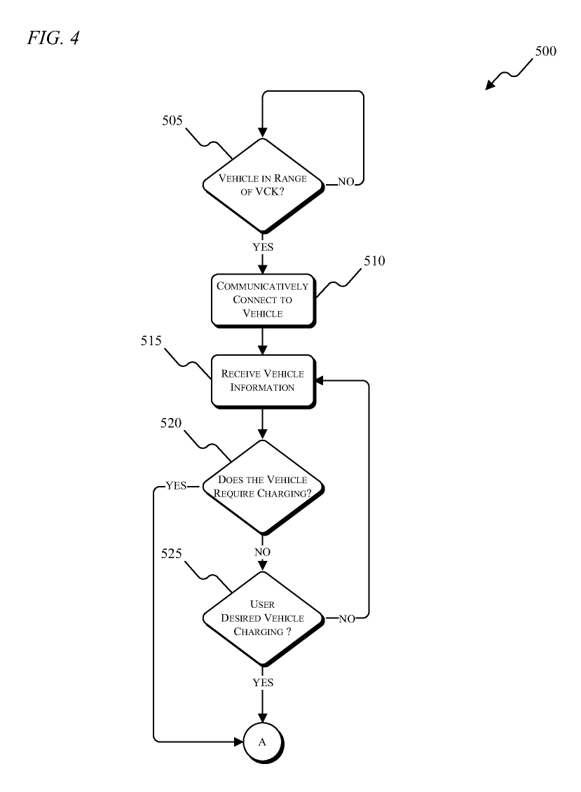

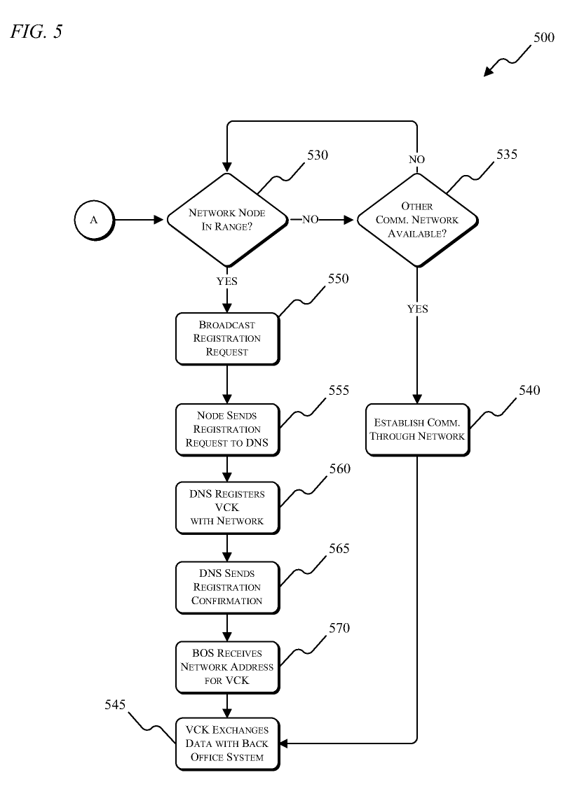

FIGS. 4-5 are a process 500 for connecting to a utility communications network and controlling or moderating the charging of a vehicle. Because a VCK can be non-integrally connected to a vehicle, the VCK is, at least potentially, out of communications range with the vehicle. As such, the VCK checks to see of there is a vehicle within communications range (step 505). For example, the VCK broadcasts a signal to establish communication with the vehicle. Additionally or alternatively, the VCK receives a signal from the vehicle to establish communication. If there are multiple vehicles in range of the VCK, the VCK distinguishes between the vehicles based on one or more vehicle identification criteria, such as a preprogrammed vehicle identification number (“VIN”), a selection of one of the multiple vehicles, or the like. The VCK communicatively connects to the vehicle (step 510) using a short-range communications network, as described above, and receives one or more sets of vehicle information (step 515). The vehicle information includes, for example, location information, vehicle status information, and battery SOC information. In some embodiments, the VCK also receives one or more signals or instructions from the vehicle. In such embodiments, the vehicle operates as a master device and the VCK operates as a slave device. In other embodiments, the VCK operates as a master device and requests information from the vehicle. At step 520, if the vehicle information indicates that the vehicle battery requires charging, or if the vehicle transmits a signal to the VCK indicating a need or preference to charge the vehicle battery, the process 500 proceeds to control section A shown in and described with respect to FIG. 5. If the vehicle information does not indicate a need to charge the vehicle, or the VCK does not receive a signal indicative of a need to charge the vehicle, the VCK determines whether a user has provided a charging preference or an indication of a desire to charge the vehicle (step 525). If the user has provided no indication of a desire to charge the vehicle battery, the process 500 returns to step 515. If, at step 525, the user provides an indication of a desire to charge the vehicle, the process 500 proceeds to control section A and FIG. 5.

The vehicle's need to charge its battery, or a desire by the user to charge the vehicle's battery, can result from a variety of situations. For example, the vehicle battery has one or more predetermined or user defined threshold values. If the SOC of the vehicle battery falls below one or more of these thresholds, the vehicle sends a signal to the VCK indicating a need to charge the vehicle battery. In some embodiments, the thresholds are established based on, for example, minimum charge requirements for the vehicle battery. Some batteries, such as lithium-ion and other lithium-based batteries are susceptible to being damaged if the voltage of the batteries falls below a minimum voltage threshold. As such, when the SOC of the vehicle battery is approaching a minimum voltage threshold, a signal is sent to the VCK indicating the need to charge. If the vehicle battery SOC reaches the minimum voltage threshold before being recharged, the vehicle is automatically disabled to prevent damage to the battery.

In other embodiments, the VCK is prompted to connect to the utility communications network based on one or more user defined charging preferences or one or more user-defined charging criteria. The preferences are related to, for example, the cost of the electricity, time of day, expectations for future driving, distance to nearest charging station, rate of power consumption, weather, and the like.

The cost required to charge a vehicle battery may be dependent upon the time of day when the vehicle is being charged. As such, the VCK is configured to allow a user to program one or more time of day or cost preferences. For example, the VCK is configured to control the charging such that the vehicle is only charged during off-peak times (e.g., between 9 PM and 7 AM), or the VCK is configured to control the charging of the vehicle such that the vehicle only charges when one or more electricity cost thresholds is satisfied. The pricing received by the VCK from BOS is substantially real-time (i.e., the delay corresponds to practical limitations to instantaneous communication, such as the latency of the utility network associated with the speed at which signals are physically able to travel from one location to another, and the time required to process the signals). As such, the VCK regularly determines the cost of electricity and is able to continually or substantially continually compare the cost of the electricity to the one or more user-defined thresholds. Additionally or alternatively, the user can use the VCK to start or stop the charging of the vehicle as desired. For example, the user can select immediate charging, delayed charging (e.g., by one hour, two hours, until a certain time, etc.), charge at a specified time, or any of a variety of additional charging preferences. In some embodiments, the substantially real-time pricing information is displayed to the user to allow the user to make informed charging decisions.

In other embodiments, the VCK controls charging based on the location of the vehicle. The location of the vehicle is sent from the vehicle to the VCK, or the VCK includes its own global positioning system (“GPS”). For example, in embodiments of the invention in which the VCK is a smartphone, the built-in GPS capabilities of phone are used to determine the location of the vehicle. The location of the vehicle is used to identify utility nodes within the travel range of the vehicle or along a travel path of the vehicle. The VCK then provides the locations of the various charging locations to the user. The VCK also provides the current cost to charge the vehicle at each location and the expected cost to charge the vehicle at each location at the time when the vehicle is expected to arrive at each location. In some embodiments, the VCK is configured to store the location and pricing data to a memory for future use or reference. For example, based on stored location and pricing information, the VCK is able to recommend charging locations and times to a user without having to connect to the BOS.

The rate at which the power stored in the vehicle battery is consumed is also used to control the connection of the VCK to the utility communications network. For example, on a warm day, the vehicle is likely to be operating a variety of electrical systems including an air conditioning system. In such an instance, the vehicle battery is depleted more quickly than when the air conditioning system is not in operation. The increased rate of depletion of the charge limits the travel range of the vehicle and causes the vehicle to provide an indication of a need to charge the vehicle sooner than normally expected.

Additionally, the VCK is configured to control charging of the vehicle based on a time entry by the user. For example, if the user provides an indication that the vehicle will not be driven a significant distance or require a significant charge over the next several days, the VCK controls the charging of the vehicle battery according to a conservative charging strategy (e.g., only during the 2-3 hours when electricity is the least expensive). Alternatively, when the user needs the vehicle battery to be charged more quickly, the VCK controls or moderates the charging of the vehicle battery at the fastest safe rate and without regard for cost to ensure that the user's charging requirements are satisfied. The vehicle battery is only able to be charged according certain predetermined charging characteristics. For example, the vehicle battery has electrical limits within which the charging rate must be maintained. These electrical limits are affected by, among other things, battery temperature, cell voltage, pressure, battery state-of-health, SOC, etc. If the electrical limits for which the vehicle battery is capable being charged change, the VCK receives an indication of a change in the charging characteristics of the vehicle and communicates with the utility network to modify the charging of the vehicle accordingly.

In some power distribution systems, renewable energy sources (e.g., wind, solar, tidal, etc.) contribute a significant amount of power (i.e., a significant percentage of total available power) to a particular power grid. In such systems, the weather plays a role in the cost of electricity for a particular day or time of day. For example, if a particular territory is heavily dependent upon solar power, a cloudy day reduces the supply of available electricity. Similarly, in territories which rely on wind power, a calm day reduces the supply of available electricity. In each of these situations, the weather has an effect on the cost to charge the electric vehicle. As such, in some embodiments, the VCK is configured to determine, based on the location of the vehicle, one or more weather related conditions which affect the supply of electricity. If the VCK determines that charging the vehicle battery will be cheaper some time in the future based on one or more weather related conditions, and the user has not provided an indication of a need for the battery to be fully charged, the VCK delays charging until the more favorable weather conditions arrive. Such a charging procedure is overridden by an indication by a user that the vehicle must be charged to a certain level before a certain time.

The VCK is also configured to control the charging of the vehicle battery to provide a trickle charge or intermittent charge. For example, when the vehicle battery needs to be charged during peak usage times, the VCK initiates a trickle (e.g., low-current charge) which gradually charges the vehicle battery to a level needed to complete an anticipated amount of driving (e.g., an amount of driving expected before the vehicle is able to be charged again). Additionally or alternatively, the VCK is configured to initiate an intermittent charge in which the vehicle battery is charged at a normal charge rate or maximum charge rate, but for only a short period of time. After a designated or determined charging period, the VCK prohibits the charging of the vehicle battery for a second predetermined period of time.

The VCK is also configured to use information received from the vehicle or an internal GPS system to identify driving habits for the vehicle. For example, someone who drives to work Monday-Friday has well-defined driving habits for most of the week. Based on the time of day, the date, and the location of the vehicle, the VCK dynamically determines the level of vehicle battery charge required for the user to complete an anticipated amount of daily driving. Such a feature allows the VCK to control the charging of the vehicle to a minimum safe level during the peak usage times, and complete charging during the off-peak times.

In some embodiments, the VCK is further configured to be substantially always connected to the utility communications network, or substantially always communicatively connected to the BOS via a different network. The VCK communicates with the utility communications network as described above to receive information, such as pricing information and the like. When one or more user defined criteria are satisfied by the information received from the utility network, the user is provided with an indication of the criteria being satisfied and various charging locations in the area. In other embodiments, the VCK is configured to connect to the utility network at predetermined intervals to check pricing information.

The VCK is also configured to receive software/firmware updates from, for example, the BOS. These updates can be used to add features and functionality to or remove features and functionality from the VCK as needed or desired. These updates are similar to the updates that the meters, utility nodes, NICs, etc. receive.

With reference to FIG. 5, the VCK determines whether any network nodes are in range (step 530). For example, when the VCK is powered up or a user indicates a desire to connect to the network, each of the network nodes in communications range of the VCK is identified. If there are no utility communications network nodes in range, the VCK is able to check for the availability of an alternative communications network with which to connect (step 535). For example, the alternative communications network is a cellular or satellite communications network. If no alternative communications networks are available, the VCK again determines whether a network node is in communications range (step 530). If there is an alternative communications network available, the VCK establishes communication with the BOS through the alternative communications network (step 540), and exchanges information or data with the BOS (step 545).

In some embodiments, the alternative communications network is a cellular network, such as, for example, a Global System for Mobile Communications (“GSM”) network, a General Packet Radio Service (“GPRS”) network, a Code Division Multiple Access (“CDMA”) network, an Evolution-Data Optimized (“EV-DO”) network, an Enhanced Data Rates for GSM Evolution (“EDGE”) network, a 3GSM network, a 4GSM network, a Digital Enhanced Cordless Telecommunications (“DECT”) network, a Digital AMPS (“IS-136/TDMA”) network, or an Integrated Digital Enhanced Network (“iDEN”) network. For example, in some embodiments, the VCK connects to a mobile switching center (“MSC”). The MSC allows the VCK to connect to a public switched telephone network (“PSTN”), and then to the BOS. In other embodiments, the alternative communications network is a satellite communications network. In such embodiments, the VCK connects to a constellation of satellites in, for example, geosynchronous orbit. The satellites forward messages from the VCK through a satellite teleport or ground station to the PSTN and then to the BOS. Embodiments of the invention described herein are described with respect to a VCK which connects to the utility communications network.

If, at step 530, a network node is in communications range, the VCK identifies the node which is able to provide the least-cost communications path through the network and broadcasts a network registration message or request (step 550). The network registration message includes, for example, a unique network address for the VCK or a portion of a network address for the VCK. The unique network address or the portion of the unique network address is operable as a universal identifier which is used to identify the VCK when, for example, the VCK is being used across multiple utility communications networks and power grid networks (e.g., when charging a rental car, when on vacation, etc.). In some embodiments, the network registration message includes a media access control (“MAC”) address for the VCK. If there is a network node in range (step 530), the network node responds to the network registration message with, for example, an acknowledgement message. If the registration message included a MAC address and not a full network address for the VCK, the acknowledgement message from the network node includes a network address prefix or suffix that is combined with the MAC address to generate a unique network address. In some embodiments of the invention, the VCK connects directly to an access point of the utility network. In other embodiments, the VCK connects to the access point through one or more additional nodes. The network registration and communication process is described in greater detail in U.S. Patent Application No. 2008/0189436, filed May 24, 2007, the entire content of which was previously incorporated by reference.

Following step 550, the least-cost node sends the network registration request including a full network address for the VCK to the DNS (step 555), and the DNS registers the VCK with the network (step 560). After the VCK has been registered with the DNS, the VCK is a node within the utility communications network, and the DNS sends a registration confirmation message to the VCK (step 565). The BOS requests or receives the network address associated with the VCK (step 570). For example, in some embodiments, the VCK sends a simple network management protocol (“SNMP”) telomere repeat amplification protocol (“TRAP”) or INFORM message to the BOS. Additionally or alternatively, the DNS signals the BOS via SNMP. The SNMP TRAP or INFORM message includes one or more IPv6 addresses for the VCK.

Following step 570, the VCK and the BOS exchange information as necessary (step 545). For example, the BOS receives the SNMP TRAP or INFORM message and replies with a generic management interface (“GMI”) data query. GMI data query message requests information related to the VCK. The GMI data query message requests vehicle information related to, among other things, vehicle battery SOC, vehicle location, user charging preferences, a payment selection, payment information, and the like. The VCK receives the GMI data query message and sends a data response message including the requested information. The VCK and the BOS exchange information on a regular, semi-regular, or continuous basis. In some embodiments, the VCK does not directly communicate with the BOS. For example, at an electric vehicle charging station, the VCK communicates with and provides payment information to the charging pump. The charging pump communicates with a BOS to authenticate or authorize a payment or the charging of the vehicle battery, and then provides charging current to the electric vehicle.

When using credit card information provided through the VCK to charge the vehicle, a plurality of BOSs are involved in the transaction. For example, the utility provider (i.e., a first BOS) is a merchant of the transaction. The utility provider sets the cost of the transaction based on, among other things, the current cost of electricity. An acquiring bank (i.e., a second BOS) is a bank or financial institution that accepts payment for products and services provided by the utility provider. A credit card organization (i.e., a third BOS), such as Visa, MasterCard, American Express, etc., sets various transaction terms for the merchant, acquiring bank, and cardholder. When the cardholder pays for electricity to charge the vehicle, the merchant submits the transaction to the acquiring bank. The acquiring bank verifies the credit card information, payment amount, and transaction type, and reserves a portion of the cardholder's credit limit for the purchase. The acquiring bank generates an approval code which is sent to the utility provider and stored with the vehicle charging transaction information. After the utility provider receives the approval code or a denial code, the utility provider generates the charge authorization signal. In some embodiments, the utility provider submits transactions to the acquiring bank in batch form, and generates the charge authorization signal without having received the approval code from the acquiring bank. The acquiring bank sends the vehicle charging transaction through the credit card association which credits the acquiring bank for the transaction. After the acquiring bank has been paid, the acquiring bank pays the utility provider for the transaction.

An Internet or web-based payment service (e.g., PayPal™) can also be used to pay for a charging transaction. For example, the VCK is configured to connect to a PayPal account via the utility communications network, or another network (e.g., a LAN, HAN, a WPAN, or the like), and electronically transfer funds from the PayPal account to the utility provider, a credit card company, or a financial institution. Additionally or alternatively, PayPal information is stored in a memory of the VCK, which allows the VCK to verify the existence of funds without being able to wirelessly connect to a network. The stored PayPal information functions in a manner similar to a prepaid credit card or prepaid debit card. When the stored PayPal account balance reaches zero, charging is stopped. The PayPal information is encrypted or secured in such a manner that funds can only be added to the account through the PayPal website. The VCK is then connected to a computer through the USB port, the PayPal information stored within the VCK is automatically synced with stored PayPal account information. If a payment for charging a vehicle was made based on the PayPal information stored in the VCK without the on-line information having been updated, the PayPal information stored in the VCK is used to update the on-line PayPal account. To ensure against fraud, the information stored in the VCK is encrypted or otherwise secured to prevent the information from being corrupted, stolen, or otherwise exploited.

In some embodiments, the user is able to prepay for electricity. For example one or more vehicle charging credits are purchased and then redeemed when the vehicle is to be charged. The vehicle charging credits are purchased using the VCK and are associated with the unique address (e.g., a network address, a MAC address, etc.) of the VCK. The credits are purchased using any of the above-described payment options, such as by credit card, prepaid account, a web-based service, or by charging them to a utility account. When the VCK connects to the utility communications network, the VCK provides a vehicle charging credit confirmation number or serial number associated with their purchase to the utility communications network.

Additionally or alternatively, a record of the purchase of the credits is maintained by one or more BOSs such that when the VCK is registered with the utility communications network, the BOS is able to authorize the charging a vehicle without requiring additional payment information from the VCK. The charging credits are transferable and, in some embodiments, valid indefinitely such that a user is able to purchase a vehicle charging credit at a current price and use the credit when the cost of electricity is higher. In some embodiments, the user is provided with charging credits when stored energy in the vehicle battery is sold back to the utility provider. For example, a user charges a vehicle at an off-peak time, and sells the electricity back to the utility provider during peak times. In some embodiments, the money earned selling electricity back to the utility provider is credited to a utility account. As previously described, pricing information can be displayed by the VCK. This allows the user to decide whether to sell energy back to the utility provider. In some embodiments, stored historically pricing and charging information is used as a metric by the VCK to determine whether it is economical to sell energy back to the utility provider.

Because the VCK is portable, it is capable of moving out of direct contact with a particular node, access point, or LAN to which it is connected. In such an instance, the access point is configured to, for example, de-register the VCK from the utility communications network. Additionally or alternatively, the VCK is de-registered if it has not been in communication with the access point for a predetermined or configurable period of time. In other embodiments, the VCK sends information to one or more access points indicating that the access points should not de-register the VCK from the utility communications network, or the network configurations at the one or more access points determine whether to de-register the VCK.

In some embodiments, if the VCK encounters a problem, such as loss of power, a security incident, a problem with its hardware or software, a network problem, etc., the VCK is configured to send a message indicating a problem to a node, an access point, a BOS, or a device which is in communications range of the VCK. If power is lost (e.g., the VCK's batteries are depleted or removed), the VCK is configured to send a “last gasp” message to an access point. In some embodiments, the last gasp message is short and includes the information necessary to conserve network and node resources, and is sent to other neighboring nodes and the associated access point. The access point forwards the last gasp message to the BOS indicating that the access point has received a last gasp message from VCK.

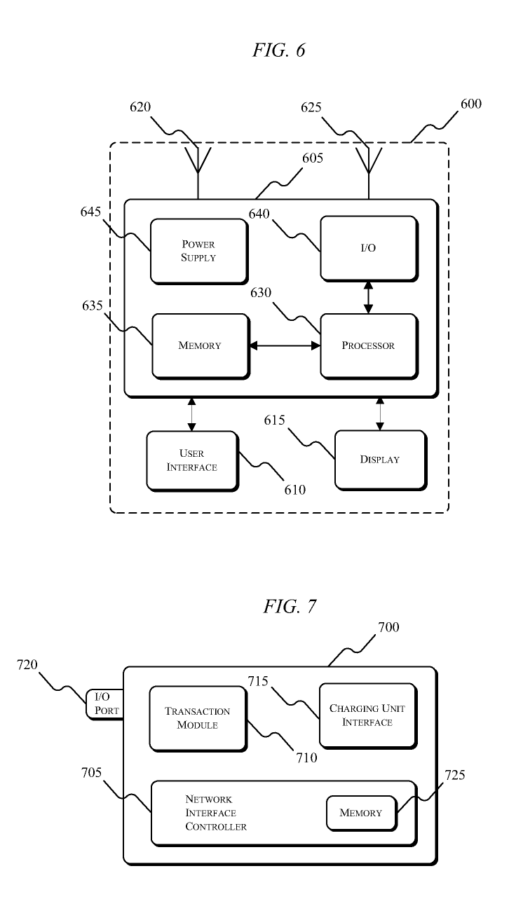

FIG. 6 illustrates a VCK 600 that includes, among other things, a control unit or controller 605, a user interface 610, a display 615, a first radio 620, and a second radio 625. The controller 605 includes, for example, a control or processing unit 630, a memory 635, and input/output (“I/O”) module 640, a power supply module 645, and one or more busses for operably and communicatively coupling the components within the controller 605. The processing unit 630 is, for example, a processor, a microprocessor, a microcontroller, or the like. The memory 635 is a read-only memory (“ROM”), a random access memory (“RAM”), an electrically erasable programmable read-only memory (“EEPROM”), a flash memory, or the like. The I/O module 640 includes, for example, routines for sending information to and receiving information from components or devices external to the controller 605 and for transferring information between components within the controller 605. Software included in the implementation of the VCK 600 is stored in the memory 635 of the controller 605. The software includes, for example, firmware applications and other executable instructions. In other embodiments, the controller 605 can include additional, fewer, or different components.

In some embodiments, the processor 630, the memory 635, and the I/O module 640 are implemented on one or more printed circuit boards (“PCBs”) (not shown) within the VCK 600. For example, the PCB is populated with a plurality of electrical and electronic components which provide operational control and protection to the VCK 600. The PCB also includes, among other things, a plurality of additional passive and active components such as resistors, capacitors, inductors, integrated circuits, and amplifiers. These components are arranged and connected to provide a plurality of electrical functions to the PCB including, among other things, filtering, signal conditioning, and voltage regulation. For descriptive purposes, the PCB and the electrical components populated on the PCB are collectively referred to as the controller 605. The controller 605 receives signals from the radios 620 and 625, user interface 610, or other components within the VCK 600, conditions and processes the signals, and transmits processed and conditioned signals to, for example, the display 615, a vehicle, a node of a utility communications network, etc.

The power supply module 645 includes a power source, such as batteries or a battery pack. In embodiments of the invention which include batteries, the batteries are alkaline-based or lithium-based batteries and are, for example, disposable or rechargeable AA batteries, AAA batteries, six-volt (“6V”) batteries, nine-volt (“9V”) batteries, or the like. In other embodiments, the VCK 600 includes a battery pack having a plurality of battery cells. The battery cells within the battery pack provide operational power (e.g., DC power) to the VCK 600. In one embodiment, each battery cell has a nominal voltage of approximately two-volts (“2.0V”), three-volts (“3.0V”), four-volts (“4.0V”), etc. The cells are arranged in series, parallel, or a series-parallel combination to achieve a desired nominal voltage for the battery pack. The battery cells are, for example, lithium-ion battery cells having a lithium-cobalt (“Li—Co”), lithium-manganese (“Li—Mn”), or Li—Mn spinel chemistry. In some embodiments, the battery cells have other suitable lithium or lithium-based chemistries. In other embodiments, the battery cells have a nickel-cadmium (“NiCd”) chemistry, a nickel-metal hydride (“NiMH”) chemistry, or another suitable nickel-based chemistry. In some embodiments, the power supply module is connected to and operably powered by the vehicle battery, or receives a charging current from the vehicle battery.

The VCK 600 is implemented in various embodiments of the invention as any of a number of devices, including a mobile phone, a smartphone, a laptop, a netbook, and e-book reader, a PDA, a keyfob, a remote, or the like. In some embodiments, the VCK 600 is integrated into or coupled to the vehicle. In embodiments in which the VCK 600 is implemented as a smartphone, the VCK 600 includes, for example, one or more mobile applications for controlling the connection to and communication with a variety of networks. The application is downloaded from a store (e.g., the Android marketplace, the iPhone app-store, etc.) accessible via the utility communications network, a cellular network, or the like. The application is stored on an internal dedicated (e.g., flash memory, ROM, EEPROM, etc.) or removable memory (e.g., an SD card) associated with the smartphone.

The display 615 is configured to display a variety of information to the user. For example, the display 615 is configured to display the vehicle battery SOC, a rate of energy consumption by the vehicle, an estimated travel distance before requiring a charge, a distance to the nearest charging location or utility network node, current electricity prices, and the like. The display 615 also displays information related to the charging of the vehicle. For example, the display 615 displays the rate at which the vehicle battery is being charged, the temperature of the battery, individual battery cell voltages for the vehicle battery, an estimated time between fully charging the vehicle battery, an estimated time before reaching a predetermined charge threshold value, and the like. The values displayed by the display 615 are provided to the VCK 600 by the vehicle, the utility communications network, or are calculated by the VCK 600 based on information received from the vehicle and the utility communications network. The user interface 610 includes, for example, a keyboard, a touch-screen interface (e.g., a capacitive touch-screen interface), one or more physical buttons, switches, levers, sliders, or sensors (e.g., optical sensors), a voice-recognition system, a biometric screening system, a trackball, or the like.

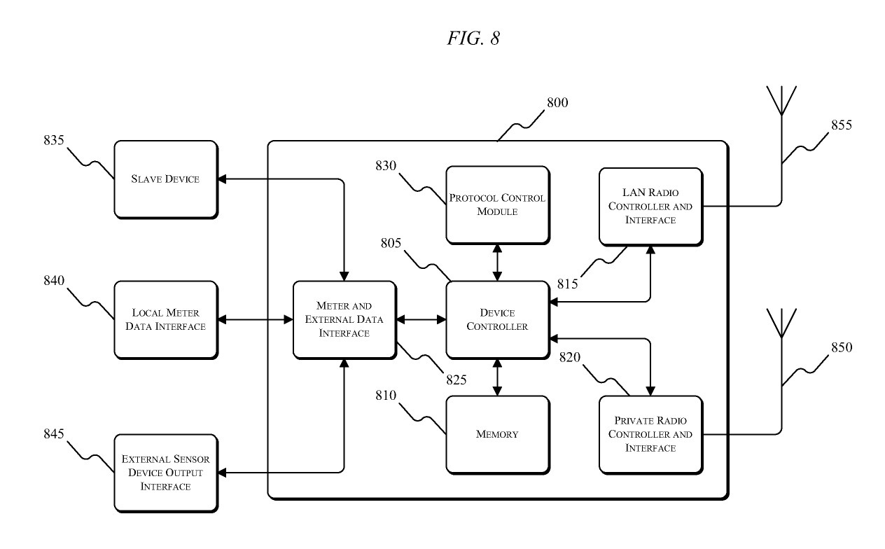

FIG. 7 illustrates a VCK 700 which is similar to the VCK 600 described above with respect to FIG. 6 and includes some of the same components. The VCK 700 includes, among other things, a NIC 705, a transaction module 710, a charging unit interface 715, and an I/O port 720. The NIC 705 includes a memory 725, such as a read-only memory (“ROM”), an electrically erasable programmable read-only memory (“EEPROM”), a flash memory, or the like. The NIC also includes one or more radios for communicating with one or more communications networks. The NIC is configured to establish communication with a vehicle using a first network, such as a LAN, a WPAN (e.g., ZigBee), etc., as described above. The NIC is also configured to connect to a BOS through a second network (e.g., a TCP/IP based network, a cellular network, etc.), as described above. The memory 725 associated with the NIC includes, for example, network configuration information, payment information (e.g., credit card information), payment selections, vehicle information, VCK identification information (e.g., a MAC address), etc.

The transaction module 710 includes among other things, the user interface 610 described above with respect to FIG. 6. The transaction module 710 is configured to receive payment selections and information from the user, provide the payment selections and information to the NIC 705, and prompt the user to enter various payment selections. For example, the transaction module 710 includes one or more virtual or computer-generated interfaces which are presented to a user on the display 615. The user provides information in response to the virtual interfaces by way of, for example, a keyboard, a touch-screen interface, one or more physical buttons, voice-recognition technology, or the like. Among the interfaces are a password, PIN, or security word entry interface, a credit card information entry interface, a browser, a network configuration interface, a vehicle information interface, and pricing interface. The charging unit interface 715 is configured to generate a charging enable signal, a charging disable signal, or a charging prohibition signal based on, for example, the charge authorization signal or one or more charging preferences. The charging enable signal is sent to a vehicle or a charging station to allow the charging of the vehicle to begin. The charging disable signal is sent to the vehicle or a charging station to cause the charging of the vehicle to be stop or suspended, and the charging prohibition signal is sent to a vehicle or a charging station to prevent the vehicle from being charged.

The I/O port 720 is, for example, a USB port, and SD card slot, a FireWire, etc. The I/O port 720 is used to connect the VCK 700 to a second device, such as a home computer, a vehicle, a phone, a laptop, or the like. Information stored in the VCK 700 is transferred to the second device. The information is used to automatically or manually update or back-up the information (e.g., sync the devices). The I/O port 720 is used to, for example, back-up the information stored within the VCK 700, modify prepaid account settings, modify charging preferences, modify network connection preferences, and the like. As is described in greater detail below, the I/O port 720 is also used to make charging payments. In some embodiments, the VCK 700 physically connects to the vehicle and the user triggers charging of the vehicle by making a selection on the user interface 610.

FIG. 8 is a block diagram of a utility node 800 of the utility communications network described above. In some embodiments, the utility node 800 includes a device controller module 805, a memory module 810, a LAN radio controller and interface module 815, a private radio controller and interface module 820, a meter and external data interface module 825, and a protocol control module 830. The meter and external data interface module 825 is configured to connect to one or more additional devices, for example, a slave device 835, a local meter data interface 840, and an external sensor device output interface 845. The protocol control module 830 is configured to receive and send data packets (e.g., IPv6 packets), as well as create or maintain network tunnels, encapsulate packets, and de-encapsulate packets as needed. In some embodiments, the utility node 800 includes a meter for metering a commodity, a private network radio 850, or a LAN radio 855, and is implemented using one or more computers, electronic devices, or radios.

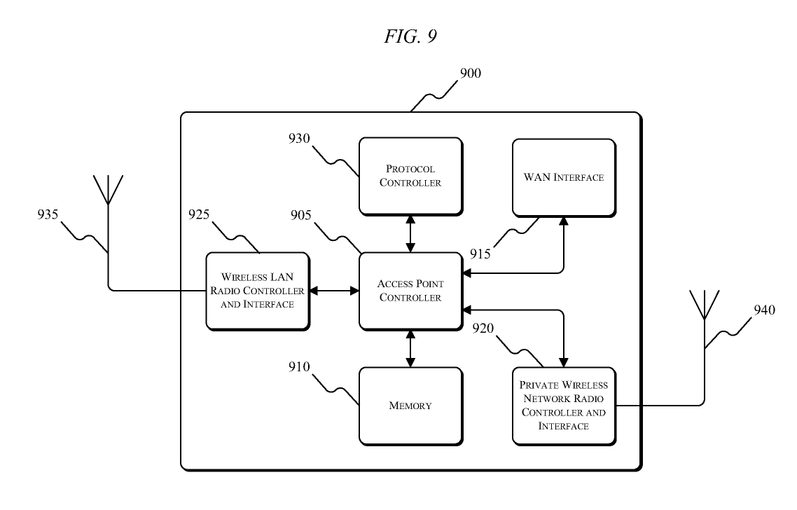

FIG. 9 is a block diagram of an access point 900 of the utility communications network described above. The access point 900, which is also operable as a gateway to other nodes in the utility network, includes an access point controller module 905, a memory module 910, a WAN interface module 915, a private wireless radio network controller and interface module 920, a wireless LAN radio controller and interface module 925, and protocol controller module 930. In some embodiments, the protocol controller module 930 includes a tunnel broker and a 6-in-4 formatter. In other embodiments, a tunnel broker is separate from the protocol controller 930. In some embodiments, the access point 900 also includes one or more radios (e.g., a private network radio 940, a WAN or LAN radio 935, etc.). Additionally, although the access point 900 is described as being separate and distinct from a meter or other devices in the utility communications network, the access point 900 is also operable as or is included with a meter, a relay, or other device within the network. In some embodiments, the access point 900 is implemented using one or more computers, electronic devices, or radios. In some embodiments, the access point 900 and the utility node 800 described above with respect to FIG. 8 are the same device.

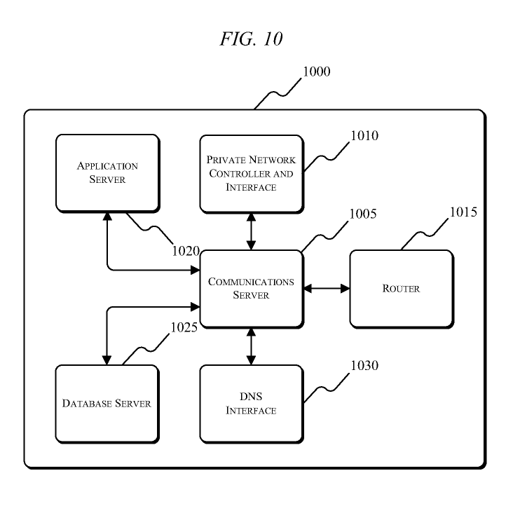

FIG. 10 is a block diagram of a BOS 1000 of the utility communications network described above. The BOS 1000 includes, for example, a communications server module 1005, a private network controller and interface module 1010, a router module 1015, an application server module 1020, a database server module 1025, and a DNS interface 1030. The private network controller and interface module 1010 is configured to communicate with a private wireless network, and the router module 1015 communicates with a WAN. In some embodiments, the router 1015 includes a 6-in-4 formatter having a tunnel broker. In other embodiments, the tunnel broker is distinct and separate from the router or 6-in-4 formatter. The application server module 1020 includes types of applications used in or required by the utility communications network. For example, the applications include billing applications, accounting applications, outage detection applications, management applications, configuration applications, provisioning applications, network applications (e.g., a proxy server, a DNS, a storage application, a back-up application, a recovery application, a customer interface application that allows a customer to control characteristics of a node or the operation of the node, a VCK manager application, a content management application, a content delivery system application, a communication manager application, a communication application, or the like. In some embodiments, the BOS 1000 is also configured to aggregate or include multiple applications, such as an accounting system, a customer billing system, etc. In other embodiments, the BOS 1000 includes a billing system and a proxy server. In some embodiments, the BOS 1000 is implemented using one or more computers (e.g., one or more servers in a data center), or one or more computers at one or more locations. The utility node 800, the access point 900, and the BOS 1000 are described in greater detail in U.S. Patent Application No. 2008/0189436, filed May 24, 2007, the entire content of which was previously incorporated by reference.

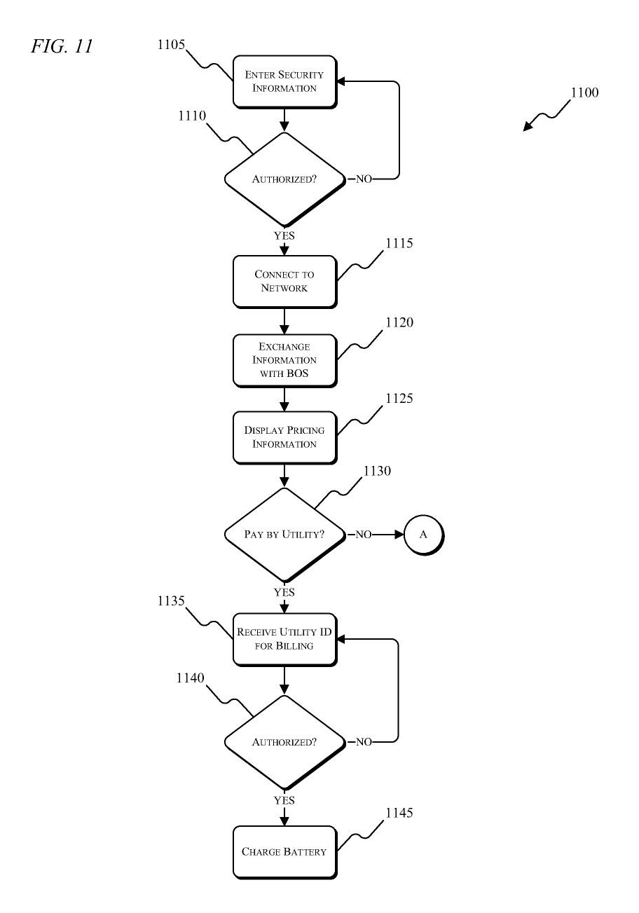

FIGS. 11-13 illustrate a process 1100 for controlling the charging an electronic vehicle using a network. The process 1100 is used to charge a vehicle and pay for the charging of the vehicle when the vehicle is or is not at the user's primary residence. For example, when the vehicle is at an electric vehicle charging or filling station, when the vehicle is at a friend's house, and when the vehicle is in a different power distribution territory (e.g., a different state, a different region, etc.) the process 1100 allows the user to direct the cost of charging the vehicle to a credit card, prepaid credit card, utility account, or the like. A user accesses the VCK using a password, passkey, or similar security information to acknowledge their authorization to use the VCK (step 1105). In some embodiments, the password is entered using an alphanumeric keypad, a graphical keypad, a touch screen interface, or the like. In other embodiments, the user accesses the VCK using voice recognition, retinal scanning, finger printing, or one or more additional biometric security measures. The VCK processes the security information received from the user to determine whether the user has authorization to access the VCK (step 1110). If the security information does not match the security information stored in the VCK, the user is prompted to re-enter the security information (step 1105). In some embodiments, the user is only given three opportunities to correctly enter the security information. If, after three attempts, the user fails to correctly enter the security information, the VCK enters a tamper-proof mode which prevents the VCK from authorizing any vehicle charging. The tamper-proof mode ends only upon entry of, for example, a master code, a physical key, or the like, or after a predetermined period of time. If, at step 1110, the security information entered by the user is correct, the process 1100 proceeds to step 1115.

A signal is generated which is related to a need or desire to charge the vehicle battery. This signal is generated based on any of a plurality of circumstances. As described above, the VCK is communicatively connectable to the vehicle. The vehicle provides, among other things, SOC information to the VCK while the VCK is in communication range of the vehicle. In some embodiments, the signal is generated in response to receiving an indication from the vehicle that the vehicle battery requires charging. Such an indication results from, among other things, the SOC of the vehicle battery falling below one or more predetermined or previously calibrated threshold values. In other embodiments, the signal is generated based on a user's indication of a desire to charge the vehicle. For example, a user may wish to fully charge the vehicle before leaving on a lengthy road trip. The user then makes a selection in the interface of the VCK of a desire to charge the vehicle. Additional criteria indicative of a need or desire to charge the vehicle battery are described above.

After the charge need/desire signal has been generated, the VCK connects to the utility communications network (step 1115), and exchanges information with the BOS (step 1120), as described above. The VCK provides a variety of information to the BOS. For example, the VCK provides location information (e.g., GPS coordinates, street address, etc.), payment information, and the like. Based on the signal and this information, the BOS generates a set of pricing information which is communicated back to the VCK. The pricing information includes, for example, one or more locations where vehicle is able to be charged, a cost associated with charging the vehicle's battery, and a request for payment information. The pricing information is presented to a user on a display (step 1125) in any of a variety of formats. The user is able to change or select the format in which the pricing information is presented. In some embodiments, the pricing information is presented as a plurality of charging locations near the VCK (e.g., as a map) and the respective cost to fully charge the vehicle battery. In other embodiments, the pricing information is presented as a range of different costs to charge the vehicle battery. For example, pricing information from one or more charging locations and respective costs to charge the vehicle to 25% of full charge, 50% of full charge, 75% of full charge, and full charge are provided for each charging location. In other embodiments, different pricing calculations associated with charging the vehicle battery are presented (e.g., estimated costs to charge the vehicle at different times). The user is also able to select charging based on a dollar amount. For example, the user is able to select a $5 limit for the amount of electricity provided to the vehicle to charge the vehicle battery.

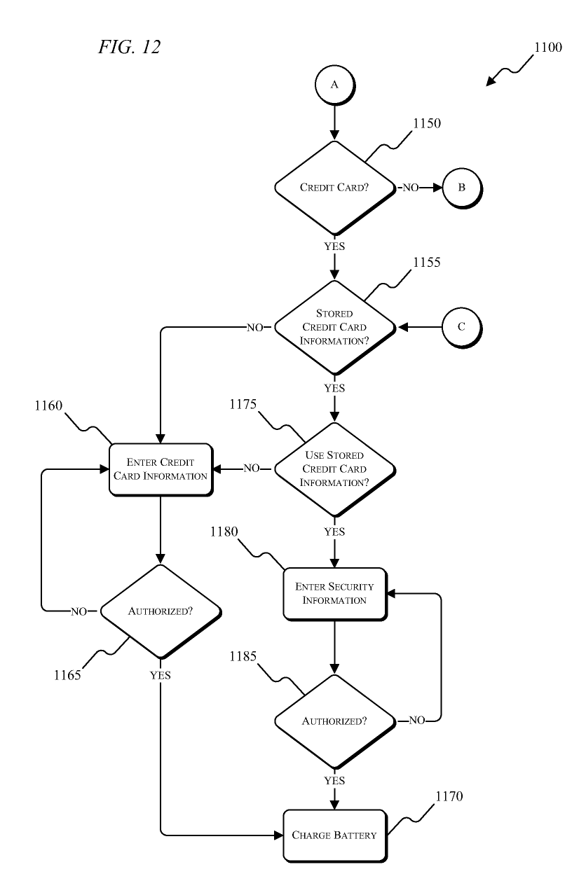

After the pricing information has been presented to the user, the user is prompted for a payment selection. The user has a variety of payment options. Depending on the SOC information received from the vehicle, the user selects between, for example, no charging, pay by credit card, pay by prepaid credit card, pay by utility bill, pay by online service, etc. At step 1130 a determination is made as to whether the payment selection included a payment type of utility bill. If the user selects to pay by utility bill, the process 1100 proceeds to step 1135. If the payment selection includes a payment type that is not by utility bill, the process 1100 proceeds to control section A shown in and described with respect to FIG. 12. If the payment type was by utility bill, the BOS identifies the VCK using network address, unique identifier, or utility account ID (step 1135), and links the payment amount for charging the vehicle to the user's utility account (e.g., a home utility account).

As described above, the VCK communicates through the utility communications network to the BOS by way of a unique identification or network address. If, at step 1140, the network address or utility ID associated the VCK is authorized to charge the payment amount to the utility account, the BOS sends a charge authorization signal to the VCK. The VCK receives the charge authorization signal and generates a corresponding charge enable signal or charge prohibition signal. For example, when the VCK is authorized to charge a payment amount to a utility account, the VCK generates the charge enable signal, which is then sent to the vehicle, and the vehicle battery is able to be charged (step 1145), and the payment amount associated with charging the vehicle battery is added as a charge to the user's utility account balance. When the VCK is not authorized to charge the payment amount to a utility account, the VCK generates the charge prohibition or charge disable signal based on the charge authorization signal from the BOS. In some embodiments, the charge enable or charge prohibition signals control a switch within the vehicle which controls the flow of charging current to the vehicle battery. In other embodiments, the charge enable or charge prohibition signals are sent to a node associated with the physical charging location, and the charging location prevents charging current from being sent to the vehicle by way of one or more distribution automation mechanisms or devices.

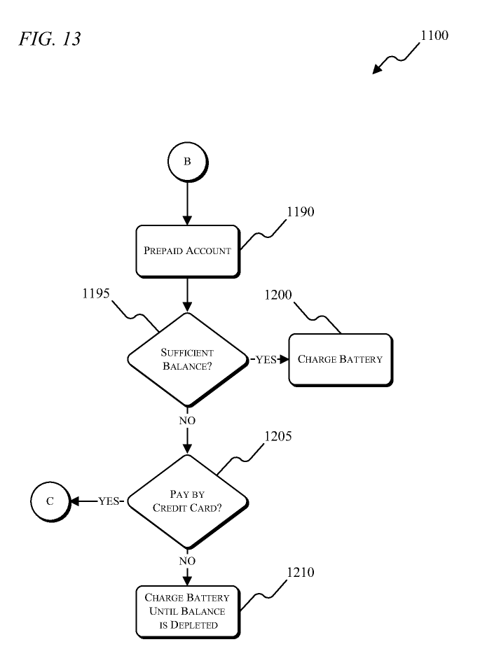

With reference to FIG. 12 and control section A, if the payment selection did not include a payment type of utility bill, the payment type is compared to a credit card payment type (step 1150). If the payment type is not a credit card, the process 1100 proceeds to control section B shown in and described with respect to FIG. 13. If the payment type is a credit card, the BOS determines whether there is stored credit card information associated with the VCK (step 1155). If there is no stored credit card information associated with the VCK, the user is prompted to enter payment information using the transaction module of the VCK (step 1160) (e.g., via a touch-screen interface, magnetic card reader, RFID, or the like). In other embodiments, credit card information is stored in the VCK and is transmitted to the BOS. In some embodiments, the credit card information is transmitted to one or more BOSs to determine whether the credit card information is valid (step 1165), as described above. If the credit card information is not valid or the user is not authorized to make a payment using the entered credit card information, the user is prompted to enter a different set of credit card information. In some embodiments, the user is only allowed to enter unauthorized credit card information three times before the VCK enters a lock-out security mode. If, at step 1165, the credit card information is valid the user is authorized to use the credit card, the BOS sends a charge authorization signal to the VCK. Based on the charge authorization signal, the charging of the vehicle battery is selectively controlled or moderated by the VCK (step 1170). For example, the VCK generates a charge enable signal which allows the vehicle to begin charging. In some embodiments, the VCK is only authorized to charge the vehicle up to a predetermined credit limit for the credit card. For example, if a user is carrying a high credit card balance and does not have sufficient credit to pay for a full battery charge, the VCK generates and sends a charge enable signal to the vehicle until the predetermined credit limit is reached. When the credit limit is reached, the VCK generates a charge prohibition signal which interrupts the charging of the vehicle.

If, at step 1155, there is stored credit card information associated with the network address of the VCK, the user is asked to select whether the stored credit card information is to be used for this particular charging transaction (step 1175). If the user indicates that the stored credit card information is not to be used to pay for the charging transaction, the use is prompted at step 1160 to enter different credit card information. In some embodiments, the user is able to update stored credit card information, edit stored credit card information, or add additional credit cards to the stored credit card information. If, at step 1170, the user provides an indication that the stored credit card information is to be used for the charging transaction, the user is prompted to enter a password, personal identification number (“PIN”), security word, or other security information to verify that the user is authorized to use the stored credit card information (step 1180). If, at step 1185, the entered security information is incorrect and the user is not authorized to use the stored credit card information, the user is again prompted to enter the security information (step 1180). In some embodiments, the user is only allowed to enter incorrect security information three times before the VCK enters a lock out security mode. If, at step 1185, the security information is correct, the user is authorized to use the stored credit card information, the BOS sends a charge authorization signal to the VCK, and the charging of the vehicle battery is selectively controlled or moderated by the VCK (step 1170), as described above.

With reference to FIG. 13, the payment type is a prepaid account (step 1190). The prepaid account includes, for example, a prepaid credit card, a PayPal™ account, a checking account, or the like. If the payment type is a prepaid account, the prepaid account is checked to determine whether there is sufficient balance available to charge the vehicle (step 1195). If sufficient balance is available on the prepaid account, the vehicle battery is charged and the cost to charge the vehicle is deducted from the prepaid account (step 1200). If there are insufficient funds associated with the prepaid account, the user is queried as to whether they would like to pay by credit card (step 1205). If the user selects to pay by credit card, the process 1100 proceeds to control section C and step 1155, and the credit card payment routine is executed as described above with respect to FIG. 12. If the user provides an indication that the prepaid account is to be used in spite of the insufficient balance to achieve the desired charge, the vehicle battery is charged as described above until the prepaid balance reaches zero or a predetermined overdraft maximum is reached (step 1210).

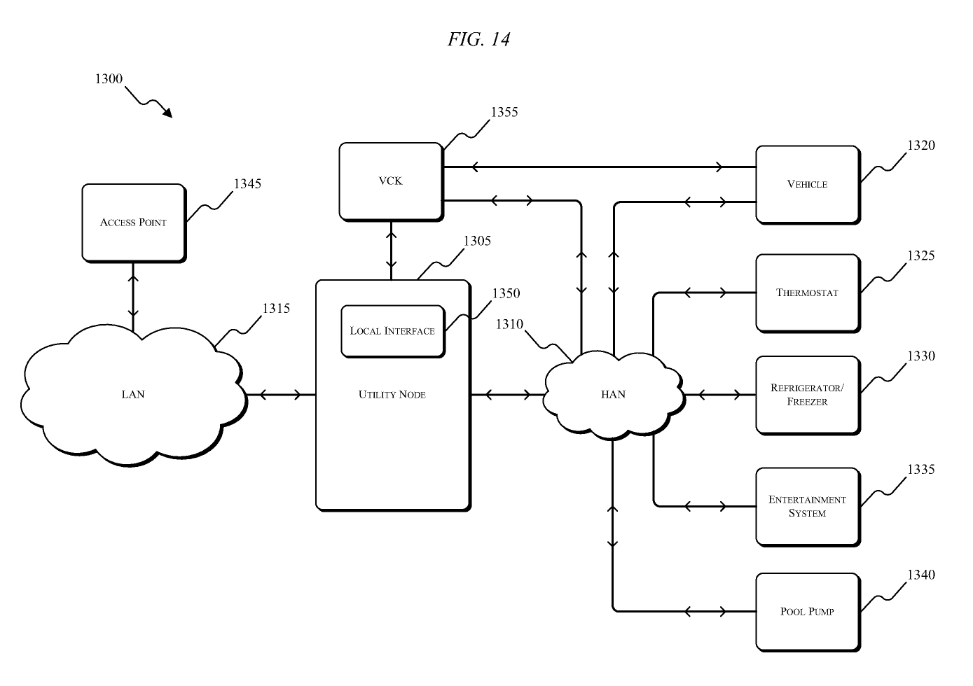

FIG. 14 is a block diagram illustrating a home utility node sub-network 1300. The sub-network 1300 includes utility node 1305, a HAN 1310, a LAN 1315, a vehicle 1320, a thermostat 1325, a refrigerator/freezer 1330, an entertainment system 1335, and a pool pump 1340. In other embodiments of the invention, additional, fewer, or different devices are included in the utility sub-network 1300. The utility node or distribution automation device includes, for example, a commodity meter (e.g., an electricity meter) or is operably interfaced with the commodity meter, and a wireless radio capable of communicating with a node or access point 1345 of a utility communications network through the LAN 1315 using an IP-based protocol (e.g., IPv4, IPv6, etc.). The utility node 1305 also includes a local or in-premise device interface 1350 for connecting to a variety of local devices. The local device interface provides, for example, a wired (e.g., Ethernet) or wireless (e.g., Wi-Fi) communications link between the utility node and the local devices 1320-1340. Additionally, the utility node 1305 is configured to provide a communications link between the local devices 1320 and the utility communications network.

In some embodiments, the local device interface 1350 assigns a network address to each of the local devices with which is operable to communicate. For example, the local device interface 1350 assigns an IP address to each of the devices. The network address assigned to the local devices is unique within the utility sub-network 1300. In some embodiments, the local device interface 1350 also shares or allows sharing of the local devices' network addresses outside of the utility sub-network 1300. As such, the local devices are directly addressable from outside of the utility sub-network 1300. In some embodiments, the utility node proxies the assigned IP address on behalf of the corresponding local device, allowing other nodes in the utility communications network to communicate with the local devices using the assigned IP address.

In other embodiments, policies, rules, or network configurations are used to determine the allocation of addresses to the local devices. The rules are based upon the device type, device attributes, network technology, network protocol used by the device, the device's commodity usage type (e.g. electric, gas, water, etc.), the device's commodity usage history, the device's commodity usage characteristics (e.g. high usage, moderate usage, etc.), the location of the device, or assigned attributes of the device (e.g., the importance of a device, the use of a device such as medical equipment, fire suppression equipment, security equipment, emergency response equipment, etc.), or based on attributes assigned by a user of the device. In some embodiments, the rules combine multiple of the above factors, such as, for example, the type of device, the electrical power consumption of the device, and whether the device is related to security or emergency response.

In the illustrated embodiment, the utility node 1305 is deployed in a residential unit and is configured to communicate with local devices (e.g., in-premise devices or devices near the residential unit) through one or more of the above-described protocols and technologies. For example, the utility node communicates with the local devices using a WPAN or using power line carrier (“PLC”) communications with PLC capable devices that receive power from the residential unit's power grid. In the illustrated embodiment, the utility node 1305 communicates with the vehicle 1320 or VCK 1355 via a WPAN, the thermostat 1325 via a WPAN, the pool pump 1340 via a WPAN, the refrigerator/freezer 1330 via a PLC, and the entertainment system 1335 via a WPAN. The utility node 1305 communicates in a wired or wireless manner with the utility network using a communications protocol such as IPv6.

The utility node 1305 includes an electricity usage meter which monitors and reports the electrical usage of the home to the utility communications network. In some embodiments, the utility node 1305 also includes an interface for connecting to additional commodity meters, such as a natural gas meter. The utility node 1305 assigns an IPv6 address to each of the local devices or commodity meters and shares the assigned network address for the devices with the utility communications network. In some embodiments, the network addresses of the local devices are shared with a local management portal that is connected to the utility communications network and allows a user to monitor and control the local devices. For example, the user is able to communicate with the local devices using the assigned IP address for each device. In such embodiments, the utility node receives data packets intended for the local devices, identifies the intended local device based on the assigned IP address, and forwards the data packets to the intended local device using an appropriate network.

When charging a vehicle from the home utility sub-network 1300, the power required to charge the vehicle 1320 is capable of greatly increasing the monthly electricity charges for the sub-network 1300 or over-burdening the power distribution circuits in the sub-network 1300 (e.g., trip a breaker). For example, many homes or utility sub-networks do not have infrastructure (e.g., wires, breakers, outlets, etc.) dedicated to charging an electric vehicle. As such, the electric vehicle 1320 is charged using circuitry that is, potentially, shared among a variety of devices. The VCK 1355 is configured to communicate with the utility node 1305 as described above. The VCK 1355 is also configured to directly communicate with the other local devices (e.g., the refrigerator/freezer 1330, the pool pump 1340, the thermostat 1325, etc.) using the HAN 1310. Based on the power requirements of the various devices, the cost of the electricity, one or more user-defined charging criteria, and the amount of charge required by the vehicle 1320, the VCK 1355 generates a vehicle sub-network charging profile. In some embodiments, the vehicle sub-network charging profile is generated by the utility node 1305. The vehicle sub-network charging profile causes the vehicle battery to be charged when the charging does not place a burden on the sub-network 1300. In some embodiments, the VCK 1355 is configured to connect to the utility communications network as a node within the utility communications network as described above. In such embodiments, the VCK 1355 communicates with the utility node 1305 but operates independently of the utility node 1305. Alternatively the VCK 1355 operates independently of the utility node 1305 and does not communicate with the utility node 1305.

As described above, it is often desirable to charge the vehicle battery during off-peak times. However, even during off peak times, charging the vehicle battery puts strain on the sub-network 1300. As an illustrative example, during the summer months, a central air unit controlled by the thermostat 1325 and the refrigerator/freezer 1330 run at periodic intervals during the off-peak times. In such an instance, the VCK 1355 controls the charging of the vehicle battery such that it only charges when the central air unit and the refrigerator/freezer 1330 are not running. In other embodiments, the vehicle charging is controlled based on one or more operational characteristics of different appliances.

Thus, the invention provides, among other things, systems and methods for controlling the charging of electric vehicles or gas-electric plug-in hybrids. The systems include a vehicle charging key (“VCK”) which is configured to establish communication with both a vehicle and a utility communications network. The VCK receives information from the vehicle related to, among other things, a vehicle battery state-of-charge (“SOC”), and transmits all or a portion of the information received from the vehicle, as well as a payment selection, to a back office system (“BOS”) associated with the utility communications network. The BOS is configured to generate a charge authorization signal to the VCK. Based on the charge authorization signal, the VCK selectively controls or moderates the charging of the vehicle battery. Various features and advantages of the invention are set forth in the following claims.

What is claimed is:

1. A vehicle charging device configured to communicatively connect to a vehicle, the vehicle including a rechargeable battery, the vehicle charging device comprising:
a transaction module configured to
receive a charging preference, and
generate payment information including a payment selection, the payment selection including a payment type that is at least one of a credit card, a prepaid debit card, a web-based pay service, and a utility account; and
a self-configuring network interface module configured to
transmit a network registration signal to a communications network to register the vehicle charging device as a node within the communications network,
receive state-of-charge information from the vehicle related to the rechargeable battery,
receive charging information from a back office system related to a cost of charging the rechargeable battery,
transmit the payment information to a back office system, and
receive a charging authorization signal based on the payment information.

2. The vehicle charging device of claim 1, wherein the vehicle charging device is configured to prevent the rechargeable battery from being charged based on the charging authorization signal.

3. The vehicle charging device of claim 1, wherein the network interface module is further configured to provide the state-of-charge information to the back office system.

4. The vehicle charging device of claim 1, wherein the network interface module is further configured to provide a charging enable signal to the vehicle based on the charging preference.

5. The vehicle charging device of claim 4, wherein the network interface module is further configured to provide a charging disable signal to the vehicle based on the charging preference.

6. The vehicle charging device of claim 5, wherein the charging preference is associated with a cost to charge the rechargeable battery.

7. The vehicle charging device of claim 1, wherein the network interface module is further configured to communicatively connect to a battery charging station.

8. A vehicle charging device configured to communicate with a vehicle, the vehicle including a rechargeable battery, the vehicle charging device comprising:
a transaction module configured to
receive a charging preference, and
generate payment information including a payment selection; and
a self-configuring network interface module configured to
transmit a network registration signal to a communications network to register the vehicle charging device as a node within the communications network,
transmit the payment information to a back office system, and
receive a charging authorization signal based on the payment information.

9. The vehicle charging device of claim 8, wherein the payment selection includes a payment type that is at least one of a credit card, a prepaid debit card, a web-based pay service, and a utility account.

10. The vehicle charging device of claim 8, wherein the network interface module is further configured to receive state-of-charge information related to the rechargeable battery.

11. The vehicle charging device of claim 8, wherein the charging authorization signal includes a payment acknowledgment.

12. The vehicle charging device of claim 8, wherein the charging authorization signal includes a vehicle charging acknowledgement.

13. The vehicle charging device of claim 8, wherein the charging authorization signal prevents the rechargeable battery from being charged.

14. The vehicle charging device of claim 8, wherein the network interface module is further configured to communicatively connect to the vehicle.

15. The vehicle charging device of claim 14, wherein the network interface module is further configured to receive state-of-charge information from the vehicle related to the rechargeable battery.

16. A vehicle charging device configured to communicate with a vehicle, the vehicle including a rechargeable battery, the vehicle charging device comprising:
a transaction module configured to moderate a vehicle battery charging payment transaction;
a network interface controller configured to communicate with a back office system and receive a charge authorization signal based on the vehicle battery charging payment transaction; and
a charging unit interface configured to generate a charge enable signal based on the charge authorization signal.

17. The vehicle charging device of claim 16, wherein the vehicle battery charging payment transaction includes a payment selection and a payment type, the payment type being at least one of a credit card, a prepaid debit card, a web-based pay service, and a utility account.

18. The vehicle charging device of claim 16, wherein the network interface controller is further configured to receive state-of-charge information related to the rechargeable battery.

19. The vehicle charging device of claim 16, wherein the network interface controller is further configured to transmit a network registration signal to a communications network to register the vehicle charging device as a node within the communications network.

20. The vehicle charging device of claim 19, wherein the network interface controller is further configured to transmit a set of payment information through the communications network to the back office system, the set of payment information including a payment selection and a payment type, the payment type being at least one of a credit card, a prepaid debit card, a web-based pay service, and a utility account.
